(19) United States
(12) Patent Application Publication
(10) Pub. No.: US 2009/0292081 A1
(43) Pub. Date: Nov. 26, 2009

(54) Alternative Crosslinking Technology

(75) Inventor: Kevin Grant Suddaby, Morrisville, NC (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Bangkok Synthetics Co., Ltd., Bangkok (TH)

(21) Appl. No.: 12/325,469

(22) Filed: Dec. 1, 2008

Related U.S. Application Data
(60) Provisional application No. 61/005,702, filed on Dec. 7, 2007.

(51) Int. Cl. C08F 8/42

(52) U.S. Cl. 525/370

(57) ABSTRACT

Compositions capable of being cured and imparting durability, in the absence or without the use of conventional sulfur-based cure systems, are disclosed. The compositions include a carboxylated base polymer and an aluminum compound, wherein the aluminum compound comprises a retarding anion. The compositions can be used to form elastomeric articles of manufacture such as gloves, condoms, and finger cots, and as binders and coatings. Retarding anions are those which require time to dissociate from the aluminum ion, thereby delaying the crosslinking of the carboxylated polymer. The aluminum compounds can be used to manufacture gloves from aqueous dispersions of the carboxylated polymers, including, for example, carboxylated nitrile latexes, in a coagulant dip process.

### FIELD OF THE INVENTION

The present invention relates to synthetic polymer compositions useful in a variety of fields including making elastomeric articles of manufacture. Particularly, compositions of the present invention are useful in crosslinked films, coatings, binders, gaskets and the like. The compositions are particularly useful when there is a need to achieve durability while avoiding the use of conventional cure systems, namely sulfur-based systems.

### BACKGROUND OF THE INVENTION

Carboxylated polymers comprising aliphatic diene monomers are widely used in a number of applications such as films, binders, and coatings. These polymers are often crosslinked or cured when used.

One area where the crosslinking of carboxylated polymer compositions comprising aliphatic diene monomers is of interest is in the manufacture of gloves from aqueous dispersions; for example the manufacture of nitrile (carboxylated butadiene acrylonitrile copolymer) gloves through coagulant dipping processes. In these processes the aqueous polymer dispersion typically contains a zinc oxide in addition to a sulfur-based cure system. This cure package imparts two types of crosslinking in the finished gloves, so-called ionic crosslinks and sulfur crosslinks. The ionic crosslinks results from interaction of the carboxylated polymer with zinc from the zinc oxide to form zinc-carboxylate linkages. These zinc based ionic crosslinks impart significant tensile strength to the finished glove. However metal-carboxylate crosslinks tend to be labile and subject to rearrangement under the influence of mechanical stress, heat, and polymer solvents and typically zinc based ionic crosslinking alone will not impart adequate durability to a glove. Sulfur-based crosslinking results in the formation of covalent bonds between polymer chains. The sulfur crosslinks, while not usually major contributors to modulus and tensile strength in these systems, do impart durability to a glove. As covalent bonds, the sulfur crosslinks are less labile and more resistant to rearrangement.

Many polyvalent metal ions have been proposed as being useful in crosslinking although crosslinking effects are dependant on the specific polyvalent metal ions used. Similarly, the chemical compounds that serve as the sources of these ions have an influence on their effectiveness as crosslinking agents. For example U.S. Pat. No. 5,181,568 discloses the use of polyvalent metal ions in conjunction with retarding anions for delayed gellation (crosslinking) of aqueous solutions of carboxylated polymers in enhancing oil recovery. Retarding anions are those anions which require time in water to disassociate from the polyvalent metal and make it available for crosslinking. Compounds of polyvalent metal ions with retarding anions act as delayed crosslinking agents.

Sulfur-based cure systems are widely used in polymer compositions comprising aliphatic diene monomers. These sulfur-based cure systems generally consist of sulfur and vulcanization accelerators such as thiazoles, sulfonamides, dithiocarbamates, and thiurams. In many applications it would be desirable to eliminate the use of sulfur-based curing since several deficiencies are associated with the use of these systems. For example, residues from accelerators have been implicated in Type IV allergies, nitrosamine formation, copper staining, and contamination. The potential also exists for curing agents or curing agent residues that are not bound to the polymer to bloom to the surface of the polymer. In practice this is sometimes seen as sulfur blooming and is undesirable since it can lead to particulate contamination, a particular concern in controlled environments.

U.S. Pat. No. 5,997,969 and U.S. Pat. No. 6,624,274 disclose a number of alternatives to sulfur-based cure systems. These alternatives involve incorporating crosslink accepting functionality into the polymer and the use of an additional crosslinking agent.

There, however, continues to be a need for systems capable of curing carboxylated polymers comprising aliphatic diene monomers in the absence of sulfur and accelerators. These systems should yield crosslinked polymers having the desirable properties of conventional sulfur-cured polymers (e.g. durability, and low modulus) while obviating the undesirable features of conventional sulfur-cured polymers, namely blooming, Type IV allergies, nitrosamine formation, copper staining, and contamination associated with sulfur or accelerator residues.

### SUMMARY OF THE INVENTION

To these ends, and to other objects and advantages, the present invention provides compositions capable of being cured and imparting durability in the absence or without the use of conventional sulfur-based cure systems. The composition is comprised of a carboxylated base polymer and an aluminum compound wherein the aluminum compound comprises a retarding anion. Uses of such compositions include films to form elastomeric articles of manufacture such as gloves, condoms, and finger cots, and as binders and coatings. In some embodiments the base polymer is in the form of an aqueous dispersion. In some embodiments the composition includes other metal compounds such as zinc oxide.

The aluminum compounds include aluminum cations, and one or more retarding anions. Retarding anions are those which require time to dissociate from the aluminum ion, thereby delaying the crosslinking of the carboxylated polymer. Examples of retarding anions include, but are not limited to, lactate, glycolate, acetylacetonates, acetylacetate esters, citrate, tartrate, gluconate, and nitriloacetates. In one embodiment, these retarding agents have no carboxylic acid groups, in another embodiment, they have only one carboxylic acid group, and in another embodiment, they have more than one carboxylic acid group. The zinc compound can be zinc oxide, or other zinc compounds used to ionically crosslink carboxylic acid-containing polymers.

These aluminum compounds have a balance of properties that make them especially suitable for this type of application, and are distinct from the aluminum compounds used in the prior art with carboxylated base polymers comprising conjugated aliphatic diene monomers to form aluminum-carboxylate linkages. The aluminum compounds are relatively stable in aqueous solution (unlike, for example organo-aluminum compounds such as aluminum alkyls or alkoxides), they are compatible with aqueous polymer dispersions such as emulsion polymers (i.e. they do not have a strong destabilizing effect, like, for example, alums or aluminum sulfates, aluminum chloride, aluminum bromide, aluminum nitrate, and polyaluminum chlorides), and they provide the aluminum in a form where it is available for crosslinking with carboxylate groups (unlike, for example, aluminas and aluminosilicates).

The aluminum compounds can be used to cure the carboxylated polymer. In one embodiment, articles of manufacture prepared from carboxylated latexes by a coagulant dipping processes are cured using the aluminum compounds. The crosslinking imparted by the aluminum compounds provides the articles of manufacture with a desirable balance of properties such as durability and low modulus in the absence of sulfur-based curing.

Stability is an important consideration for any material to be used commercially. The compatibility of the aluminum compound with polymer emulsions (for example, carboxylated latexes) is critical for uses such as coatings, binders, or the manufacture of latex goods where the crosslinking components are compounded into the water-borne formulation.

The availability of the aluminum in the aluminum compound determines the effectiveness of the compound as a crosslinking agent.

For example, the polymers can be crosslinked to form films and/or dipped goods, without using vulcanization, and the aluminum compound (alone or in combination with a zinc compound) provides appropriate durability and strength properties for such films and/or goods.

The polymer is formed by the polymerization of one or more carboxylic acid-containing monomers or their salts. Examples of suitable carboxylic acid-containing monomers include, but are not limited to itaconic acid, maleic acid, fumaric acid, maleic anhydride, (meth)acrylic acid, and crotonic acid. In one embodiment, the monomer mixture used to prepare the resulting carboxylated polymer further includes C₄₋₈ conjugated diene monomers, such as butadiene. In another embodiment, the monomer mixture further includes one or more of styrene, butadiene, (meth)acrylonitrile, and (meth)acrylate monomers in addition to the carboxylic acid-containing monomer(s).

Surprisingly, unlike the metal ion sources such as zinc oxide that are typically used in the curing of carboxylated latexes, aluminum compounds of the type that are the subject of this disclosure are effective alternatives to sulfur crosslinking for imparting durability to carboxylated polymers, such as butadiene-based polymers. Zinc oxide or other zinc compounds can be present to impart additional strength to the polymers.

The aluminum compounds that are the subject of this disclosure can be used to manufacture gloves from aqueous dispersions of the carboxylated polymers, including, for example, carboxylated nitrile latexes, in a coagulant dip process.

In one embodiment, the aqueous dispersions of the carboxylated polymers are compounded with the aluminum compounds before the form is dipped into the dispersion. In another embodiment, the aluminum compounds are present in the coagulant solution into which the form is dipped. In a third embodiment, the aluminum compounds are contacted with the polymer in a separate step, for example the aluminum compounds are present in a solution used as an overdip or an underdip in a coagulant dip process.

### DETAILED DESCRIPTION

The processes, polymer compositions, and articles of manufacture will be better understood with reference to the following detailed description.

### I. Aluminum Compounds

When compounding aqueous polymer dispersions with curing agents, coagulation of polymer dispersion can be an issue. The use of aluminum compounds where the counterion is a retarding agent helps minimize coagulation, or avoid it altogether.

When a curing agent is incorporated into a composition through the coagulant in a coagulant dipping process, excessive destabilization leading to non-uniform coagulation can be an issue. The use of aluminum compounds where the counterion is a retarding anion helps to control or avoid excessive destabilization.

The rate of crosslinking can be an issue when a curing agent is incorporated into a composition before film formation is complete, for example in the application of the curing agent as a overdip on the freshly formed wet film from a coagulant dipping process. If crosslinking occurs too quickly, then it can interfere with the completion of film formation, adversely affecting the finished film. The use of aluminum compounds where the counterion is a retarding anion helps to control the rate of film formation minimizing the interference with the completion of film formation, or avoiding it all together.

The aluminum compounds are compounds that include an aluminum cation and a retarding anion. Retarding anions are those anions which require time in water to disassociate from the polyvalent metal and make it available for crosslinking. Compounds of polyvalent metal ions with retarding anions act as delayed crosslinking agents. In connection with latex emulsions, the retarding anions minimize or eliminate coagulation.

Any aluminum compound can be used that crosslinks, but does not coagulate (in the case of latex emulsions) or substantially interfere with the film formation of the polymer. The crosslinking can be, for example, through interactions between the aluminum and carboxylation on the polymer. In addition to preventing coagulation, retarding anions may be useful in providing a more uniform crosslink distribution.

In one embodiment, the compound does not include any carboxylic acid groups, but includes a beta di-ketone group. In another embodiment, the aluminum compound is a compound of a monocarboxylic acid, specifically including those which include one or more hydroxyl groups. In another embodiment, the aluminum compound is a compound of a di- or polycarboxylic acid, specifically including those which include one or more hydroxyl groups.

Hydroxyacids can form compounds, for example, by forming cyclic (e.g., five or six member) ring structures including the carbonyl group from the acid, the oxygen from the hydroxyl group, and the complexed aluminum ion. Representative hydroxyacids include gluconic acid, lactic acid, and the like.

Diketones, such as acetylacetonate, and particularly those in which the two ketone moieties are separated by one carbon (i.e., beta-diketones) can also be used to complex with the aluminum.

Ketoesters, and particularly those in which the carbonyl moieties are separated by one carbon (i.e. beta-ketoesters) such as acetylacetates, can also be used to complex with the aluminum.

General structures of these three retarding anions are shown below:

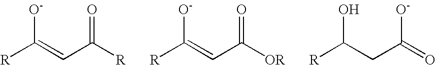

In these structures, R can be, individually, H or C₁₋₁₂ aliphatic or aromatic groups.

Representative retarding anions include but are not limited to acetylacetonate, acetylacetates, lactate, glycolate, citrate, tartrate, gluconate, and nitriloacetate. Representative compounds further include aluminum compounds containing mixed anions such as acetylacetonate, acetylacetates, lactate, glycolate, citrate, tartrate, gluconate, and nitriloacetate. In one embodiment, the aluminum compound is aluminum lactate.

### II. Monomers

The polymers that can be crosslinked using the aluminum compounds described herein include any carboxylated polymer, specifically including emulsion and solution polymers. Specific polymers include carboxylated nitrile butadiene rubber (XNBR), carboxylated styrene butadiene rubber (XSBR), and carboxylated (meth)acrylate butadiene rubbers (XMBR) which are often made by emulsion polymerization. Furthermore, unlike polymers that are cured by vulcanization, the polymers do not need to include residual carbon-carbon double bonds, and can be hydrogenated polymers (i.e., polymers which are hydrogenated to result in a very low double bond concentration).

The monomers used to prepare the polymers typically include a carboxylic acid-containing monomer (i.e., to participate in crosslinking), as well as one or more additional monomers not containing acid functionality. When used to prepare elastomeric materials such as gloves, typical additional monomers include conjugated diene monomers such as butadiene, acrylonitrile, aromatic monomers such as styrene, and chloroprene, all of which are well known in the art for their use in elastomers. However, in one embodiment, the latex composition is substantially devoid of styrene, acrylonitrile, chloroprene, and their derivatives. By “substantially devoid” is meant less than about 1.5%, ideally less than about 1%, of the monomer mixture. In another embodiment, the additional monomers comprise a combination of acrylonitrile and butadiene.

The polymer can include crosslinking agents and other additives, the selection of which will be readily apparent to one skilled in the art, and which advantageously avoids compounds, such as sulfur, thiuram or carbamate, that might result in sensitivity to the resulting latex.

Acid Monomers

A number of unsaturated acid monomers may be used in the polymer latex composition. Exemplary monomers of this type include, but are not limited to, unsaturated mono- or dicarboxylic acid monomers such as acrylic acid, methacrylic acid, itaconic acid, fumaric acid, maleic acid, and the like. Derivatives, blends, and mixtures of the above may be used. Methacrylic acid is preferably used. Partial esters and amides of unsaturated polycarboxylic acids in which at least one carboxylic group has been esterified or aminated may also be used.

Nitrile-Containing Monomers

Nitrile-containing monomers which may be employed include, for example, acrylonitrile, fumaronitrile and methacrylonitrile.

Conjugated Diene Monomers

Conjugated diene monomers can also be used. Representative conjugated diene monomers include, but are not limited to, C₄₋₉ dienes. Examples of these include isoprene and butadiene monomers such as 1,3-butadiene, 2-methyl-1,3-butadiene, and the like. Blends or copolymers of the diene monomers can also be used. A particularly preferred conjugated diene is 1,3-butadiene.

Aromatic Monomers

For the purposes of the invention, the term “aromatic monomer” is to be broadly interpreted and include, for example, aryl and heterocyclic monomers. Exemplary aromatic vinyl monomers which may be employed in the polymer latex composition include styrene and styrene derivatives such as alpha-methyl styrene, p-methyl styrene, vinyl toluene, ethylstyrene, tert-butyl styrene, monochlorostyrene, dichlorostyrene, vinyl benzyl chloride, vinyl pyridine, vinyl naphthalene, fluorostyrene, alkoxystyrenes (e.g., p-methoxystyrene), and the like, along with blends and mixtures thereof.

Crosslinking Monomers

The monomers used to prepare the polymers can include crosslinking monomers, the selection of which will be readily known to one skilled in the art. Representative crosslinking monomers include vinylic compounds (e.g., divinyl benzene); allylic compounds (e.g., allyl methacrylate, diallyl maleate); and multifunctional acrylates (e.g., di, tri and tetra (meth)acrylates).

Unsaturated Ester and Amide Monomers

The monomers can also include unsaturated ester or amide monomers. These monomers are well known, and include, for example, acrylates, methacrylates, acrylamides and methacrylamides and derivatives thereof. The acrylic and methacrylic acid derivatives may include functional groups such as amino groups, hydroxy groups, epoxy groups and the like. Exemplary acrylates and methacrylates include, but are not limited to, various (meth)acrylate derivatives including, methyl methacrylate, ethyl methacrylate, butyl methacrylate, glycidyl methacrylate, hydroxyethyl methacrylate, hydroxypropyl methacrylate, hydroxybutyl methacrylate, 3-chloro-2-hydroxybutyl methacrylate, 2-ethylhexyl(meth)acrylate, dimethylaminoethyl(meth)acrylate and their salts, diethylaminoethyl(meth)acrylate and their salts, acetoacetoxyethyl(meth)acrylate, 2-sulfoethyl(meth)acrylate and their salts, methoxy polyethylene glycol mono(meth)acrylate, polypropylene glycol mono(meth)acrylate, tertiarybutyl aminoethyl(meth)acrylate and their salts, benzyl(meth)acrylate, 2-phenoxyethyl(meth)acrylate, gamma-methacryloxypropyltrimethoxysilane, propyl(meth)acrylate, isopropyl(meth)acrylate, isobutyl(meth)acrylate, tertiarybutyl(meth)acrylate, isobornyl(meth)acrylate, isodecyl(meth)acrylate, cyclohexyl(meth)acrylate, lauryl(meth)acrylate, methoxyethyl(meth)acrylate, hexyl(meth)acrylate, stearyl(meth)acrylate, tetrahydrofurfuryl(meth)acrylate, 2(2-ethoxyethoxy)ethyl(meth)acrylate, tridecyl(meth)acrylate, caprolactone(meth)acrylate, ethoxylated nonylphenol(meth)acrylate, propoxylated allyl(meth)acrylate and the like. Other acrylates include methyl acrylate, ethyl acrylate, butyl acrylate, glycidyl acrylate, hydroxyethyl acrylate, hydroxypropyl acrylate, and hydroxybutyl acrylate.

Exemplary (meth)acrylamide derivatives include, but are not limited to, acrylamide, N-methyolacrylamide, N-methyolmethacrylamide, 2-acrylamido-2-methylpropanesesulfonic acid, methacrylamide, N-isopropylacrylamide, tert-butylacrylamide, N—N′-methylene-bis-acrylamide, N,N-dimethylacrylamide, methyl-(acrylamido)glycolate, N-(2,2 dimethoxy-1-hydroxyethyl)acrylamide, acrylamidoglycolic acid, alkylated N-methylolacrylamides such as N-methoxymethylacrylamide and N-butoxymethylacrylamide

Suitable dicarboxylic ester monomers may also be used such as, for example, alkyl and dialkyl fumarates, itaconates and maleates, with the alkyl group having one to eight carbons, with or without functional groups. Specific monomers include diethyl and dimethyl fumarates, itaconates and maleates. Other suitable ester monomers include di(ethylene glycol)maleate, di(ethylene glycol)itaconate, bis(2-hydroxyethyl)maleate, 2-hydroxyethyl methyl fumarate, and the like. The mono and dicarboxylic acid ester and amide monomers may be blended or copolymerized with each other.

Ester and amide monomers which may be used in the polymer latex composition also include, for example, partial esters and amides of unsaturated polycarboxylic acid monomers. These monomers typically include unsaturated di- or higher acid monomers in which at least one of the carboxylic groups is esterified or aminated. One example of this class of monomers is of the formula RXOC—CH.dbd.CH—COOH wherein R is a C₁₋₁₈ aliphatic, alicyclic or aromatic group, and X is an oxygen atom or a NR′ group where R′ represents a hydrogen atom or R group. Examples include, but are not limited to, monomethyl maleate, monobutyl maleate and monooctyl maleate. Partial esters or amides of itaconic acid having C₁₋₁₈ aliphatic, alicyclic or aromatic groups such as monomethyl itaconate can also be used. Other mono esters, such as those in which R in the above formula is an oxyalkylene chain can also be used. Blends or copolymers of the partial esters and amides of the unsaturated polycarboxylic acid monomer can also be used.

Optional Additional Monomers

The polymer latex composition may include additional monomers. The additional unsaturated monomer may be employed for several reasons. For example, the additional monomers may aid in processing, more specifically, help to reduce the time of polymerization of the latex. The presence of the additional unsaturated monomer may also help in enhancing the physical properties of a film, glove, or other article containing the polymer latex composition. A number of unsaturated monomers may be used and are well known to the skilled artisan.

The polymer latex composition may also include other components such as, for example, urethanes, epoxies, styrenic resins, acrylic resins, melamine-formaldehyde resins, and conjugated diene polymers (e.g., polybutadiene, styrene-butadiene rubbers, nitrile butadiene rubbers, polyisoprene, and polychloroprene). Blends, derivatives, and mixtures thereof may also be used.

Representative Monomer Compositions

The following representative monomer compositions can be used to prepare the compositions described herein.

Carboxylated copolymers of acrylonitrile with aliphatic conjugated diene monomers, (Nitriles)

Carboxylated copolymers of (meth)acrylates with aliphatic conjugated diene monomers,

Carboxylated copolymers of styrene with aliphatic conjugated diene monomers, (Styrene-butadienes, or “SBs”)

In one embodiment, the polymer compositions have one of the following ranges of monomers:

Between around 0.1 and around 50% acrylonitrile, around 50 to around 99% aliphatic conjugated diene monomer (e.g. butadiene), and around 0.1 to around 15% of an unsaturated acid monomer.

In one aspect of this embodiment, the compositions include between around 15 and 50% acrylonitrile, between around 50 and around 85% aliphatic conjugated diene monomer (e.g. butadiene), and between around 2 and around 8% of an unsaturated acid monomer.

In another aspect of this embodiment, the compositions include between around 0.1 and around 50% unsaturated ester or amide monomer, around 50 and around 99% aliphatic conjugated diene monomer (e.g. butadiene), and around 0.1 and around 15% of an unsaturated acid monomer. In one aspect of this embodiment, the compositions include between around 15 and 50% unsaturated ester or amide monomer, around 50 and around 85% aliphatic conjugated diene monomer (e.g. butadiene), and around 2 and 8% of an unsaturated acid monomer.

In yet another aspect of this embodiment, the compositions include between around 0.1 and around 65% styrene, around 35 and 99% aliphatic conjugated diene monomer (e.g. butadiene), and around 0.1 and 15% of an unsaturated acid monomer. In one aspect of this embodiment, the compositions include between around 15 and 65% styrene, around 35 and around 85% aliphatic conjugated diene monomer (e.g. butadiene), and around 2 and 8% of an unsaturated acid monomer.

Representative monomer compositions suitable for preparing latex gloves and other dipping articles are described, for example, in U.S. Pat. No. 6,369,154 and U.S. Pat. No. 5,910,533, the contents of which are hereby incorporated by reference. In one embodiment, the latex composition comprises from about 35 to 80 weight percent, preferably from about 45 to about 70 weight percent, of an aliphatic conjugated diene monomer, from about 10 to about 65 weight percent, preferably from about 20 to about 40 weight percent of unsaturated ester or amide monomer, and above 0 to about 15 weight percent, preferably about 2 to 7 weight percent of unsaturated acid monomer. Blends or copolymers of the monomers may be used.

Polymerization of the Monomers

The monomers are preferably polymerized by emulsion polymerization. This method often involves the addition of conventional surfactants and emulsifying agents during the polymerization reaction, although polymerizable surfactants that can be incorporated into the latex also can be used.

For example, anionic surfactants can be selected from the broad class of sulfonates, sulfates, ethersulfates, sulfosuccinates, and the like, the selection of which will be readily apparent to anyone skilled in the art. Nonionic surfactants may also be used to improve film and glove characteristics, and may be selected from the family of alkylphenoxypoly(ethyleneoxy)ethanols where the alkyl group typically varies from C₇₋₁₈ and the ethylene oxide units vary from 4-100 moles. Various preferred surfactants in this class include the ethoxylated octyl and nonyl phenols. Ethoxylated alcohols are also desirable surfactants. A typical anionic surfactant is selected from the diphenyloxide disulfonate family, such as benzenesulfonic acid, dodecyloxydi-, disodium salt. In addition to, or in place of the surfactants, a polymeric stabilizer may be used in the composition of the invention.

Peroxides, chelating agents (e.g., ethylenediaminetetraacetic acid), dispersants (e.g., salts of condensed naphthalenesulfonic acid); buffering agents (e.g., ammonium hydroxide); and polymerization inhibitors (e.g., hydroquinone), can also be used. Chain transfer agents (e.g., C₈-C₁₄ alkyl mercaptans, carbon tetrachloride and bromotrichloromethane) can also be used, preferably less than about 4 percent based on the weight of the monomers. More preferably, the chain transfer agent is used from about 0.0 to about 1.5 weight percent, and most preferably from about 0.3 to about 1.0 weight percent.

The monomers used in forming the polymer latex composition of the invention may be polymerized in a manner known to those who are skilled in the art. For example, the monomers may be polymerized at a temperature preferably between about 5-95° C., and more preferably between about 10 and 70° C.

In another embodiment, solution polymerization is used, wherein a solvent system in which the monomer and polymer are soluble is used. Solution polymerization and emulsion polymerization are well known to those of skill in the art.

### III. Polymer Compounding

A compound can be prepared by adding the aluminum compound and, optionally but preferably, zinc oxide, to a polymer. For example, the aluminum compound, for example, aluminum lactate, can be added to a latex dispersion or dry rubber formulation at a ratio of 0.25-5 phr, for example, about 1 phr as an aqueous solution

Zinc oxide or other suitable zinc compound can be added (as a dispersion, when used with latex) typically in an amount of between about 0 and 10 phr, more typically about 0.25-5 phr.

### IV. Formation of Films and Dipping Articles

Film Formation

Films can be prepared from a compounded latex, for example, through a coagulant dip process on ceramic plates. For example, one can use a coagulant such as a 30% aqueous calcium nitrate solution, or other suitable coagulant solution. The solution is typically applied by dipping and immediately removing hot ceramic plates (approximately 70° C.) into a room temperature coagulant solution. The coagulant coated plates can then be partially dried and dipped into the latex compound with a sufficient dwell time (for example, around 20 seconds), and then removed to form a wet film. The plates can then be leached with water to remove the coagulant (for example, for between about 2 and 10 minutes in a warm water bath). The films can then be dried (for example, at around 70° C.), and cured at elevated temperatures (for example, around 132° C.). The cured films can then removed from the plates.

Formation of Dipping Articles

Dipping articles can be made in any suitable manner. For example, suitable forms or molds in the shape of a hand can be heated in an oven, and are optionally immersed or dipped into a coagulant. A suitable coagulant includes, for example, a solution of a metal salt, preferably calcium nitrate, in water or alcohol. The form is then withdrawn from the coagulant, and the excess liquid is permitted to dry. As a result, a residual coating of coagulant is left on the form. The form coated with the coagulant is then immersed or dipped into a polymer latex composition (previously compounded with an aluminum compound and optionally with a suitable zinc compound), and the latex coagulates and forms a film on the form. The amount of time the form is immersed in the latex typically determines the thickness of the film. The longer the dwell time, the thicker the film.

The form is then removed from the latex, and is immersed in a water bath to remove the coagulant and some of the surfactant. The latex coated form is then placed in a drying oven at a temperature preferably between about 60 and about 100° C. to remove water from the film. When the film is dry, the mold is placed in a curing oven preferably at a temperature between about 100 and 170° C. for about 5 to about 30 minutes. If desired, the same oven can be used for drying and curing, and the temperature can be increased with time.

The cured glove is then removed from the form. It may be powdered or post-processed for ease of removal and for ease of donning. The glove preferably has a thickness ranging from about 3 mil to about 20 mil.

### V. Articles of Manufacture

The invention also relates to a crosslinked film formed from crosslinking the polymer latex compositions described herein with the aluminum compounds described herein, and optionally also with a zinc compound such as zinc oxide.

Numerous articles of manufacture can be formed from these crosslinked films. Such latex articles generally include those which are typically made from natural rubber and which contact the human body.

The films can be made into self-supported or form stable articles. The films are mechanically self-supporting without significant deformation, i.e., can maintain their dimensions (e.g., length, thickness, circumference, etc.) against gravity without any exterior support such as a mold. It is recognized by those skilled in the art, the article could be supported, e.g., lined if additional support is desired.

Exemplary articles of manufacture include, but are not limited to, gloves, condoms, medical devices, catheter tubes, bags, balloons, and blood pressure bags. Exemplary techniques are described in U.S. Pat. No. 5,084,514 to Szczechura et al., the disclosure of which is incorporated by reference herein in its entirety.

Another use of the polymer composition is for gaskets, such as those described in U.S. Pat. No. 6,624,274, the disclosure of which is incorporated herein by reference in its entirety. Fiber-based gaskets are currently manufactured on a paper machine, using either a Fourdrinier or Cylinder machine. Various fibers, fillers, and latex are incorporated depending on the end-performance requirements, the selection of which will be within the skill of one in the art. The primary purpose of a gasket is to seal or provide a barrier to the interfaces of imperfect or incompatible parts. The proper gasket selection is made after a careful review of the conditions the gasket is likely to encounter. This includes the condition on the flange being sealed, the amount of torque placed on the flange, the fluids that the gasket may encounter and the temperature at which the gasket is exposed.

The crosslinked films and gloves formed in accordance with the present invention may have various physical properties. Preferably, the above materials have a tensile strength of at least about 1000 psi, an elongation of at least about 300 percent, and a modulus at 100 percent elongation of no more than about 1000 psi, all without the addition of allergens such as, sulfonamides, dithiocarbamates, and thiurams. More preferably, the materials have a tensile strength of at least about 1400 psi, an elongation of at least about 400 percent, and a modulus at 100 percent elongation of no more than about 500 psi.

In addition to the above, the crosslinked film and article of manufacture produced in accordance with the invention can contain additional (at least a second) polymeric films in contact thereto so as to form composite structures. The application of the additional polymeric films may be achieved by techniques which are known in the art. For example, the polymeric films may be formed on the crosslinked film and article by coating, spraying, or “overdipping”. The resulting materials may then be dried and cured in accordance with known and accepted techniques.

The additional polymeric films may be formed from a wide number of materials including, but not limited to, neoprene, nitrites, urethanes, acrylics, polybutadiene, polyisoprene, and the like. Mixtures of the above may also be used. The additional polymeric films may be present in a variety of configurations. For example, in one embodiment, an additional film may be positioned above the crosslinked film. In a second embodiment, an additional film may be positioned below the crosslinked film. In a third embodiment, the crosslinked film may be located between two additional films. The configurations of different films may be selected as desired by the skilled artisan.

The crosslinked films may be used in conjunction with other conventional materials, such as textile substrate which may be present in the form of an article such as a glove, for example. As an example, supported gloves are well known in the art. In this instance, the crosslinked film typically covers or is lined by the textile substrate, although other configurations are possible. For the purposes of the invention, the term “textile” is to be broadly interpreted and may be formed from a variety of synthetic and natural materials such as, but not limited to, nylon, polyester, and cotton. Blends and mixtures thereof may also be used.

The crosslinked carboxylated polymers can also be used in coatings and/or laminates.

The present invention will be better understood with reference to the following non-limiting examples.

### Example 1

### Crosslinking of a Carboxylated Nitrile Latex Using Aluminum Lactate

Aluminum lactate was added to a carboxylated nitrile latex (DR3988, sold by Dow Reichhold Specialty Latex) as a 20% aqueous solution, and the pH adjusted to 7.9-8.0 by adding ammonium hydroxide. Gel content was measured initially after compounding and then at weekly increments after aging at room temperature (approximately 22° C.) and 50° C. This data (shown in Table 1, below) shows that crosslinking increased with the amount of aluminum lactate added to the latex and that crosslinking was occurring at room temperature.

TABLE 1

| Time | Aluminum | | |
|---|---|---|---|
| (Weeks) | Lactate (phr) | Temperature | Gel (%) |
| 0 | 0 | Room | 55.8 |
| 1 | 0 | Room | 56.6 |
| 2 | 0 | Room | 55.7 |
| 0 | 0.5 | Room | 62.6 |
| 1 | 0.5 | Room | 71.7 |
| 2 | 0.5 | Room | 73.0 |
| 0 | 1 | Room | 75.9 |
| 1 | 1 | Room | 82.5 |
| 2 | 1 | Room | 84 |
| 0 | 0 | 50° C. | 55.8 |
| 1 | 0 | 50° C. | 56.2 |
| 2 | 0 | 50° C. | 56.1 |
| 1 | 0.5 | 50° C. | 77.8 |
| 2 | 0.5 | 50° C. | 77.8 |
| 1 | 1 | 50° C. | 87.4 |
| 2 | 1 | 50° C. | 86.7 |

### Example 2

### Combined Mechanical and Chemical Stress Durability Testing (CMCSD)

The durability of the crosslinked films was assessed through the resistance of the polymer films to a combination of mechanical and chemical stresses. In the test, a 20.0 g weight was suspended from a 18.1 mm o.d. ring made from 1.043 mm diameter wire weighing 0.51 g. A specimen was cut from the film using an ASTM D-412 D Tensile Sample Cutting Die. The specimen of the film was folded over so that the wide ends of the specimen were aligned and clamped on the wide portion of the specimen so that the weighted ring was suspended from the center of the neck portion of the specimen when held vertically. The weighted specimen was then placed vertically in acetone at 70° F. so that the sample was completely immersed in acetone. Beginning with the immersion of the film in acetone, the time taken for the ring to break through the specimen and the weight to free fall was used to assess durability. The average of 5 samples is reported.

### Example 3

### Films Prepared Using a Conventional Vulcanization Package

A latex compound was prepared by adding 0.5 phr butyl zimate dispersion, 1 phr sulfur dispersion, 1.25 phr zinc oxide dispersion, and 1.5 phr titanium dioxide dispersion (as a pigment) to 100 phr carboxylated nitrile latex DR3988 (Dow Reichhold Specialty Latex). During the compounding the pH was raised to 9.4 using ammonium hydroxide and the total solids of the system taken to 30% by adding demineralized water. The compound was allowed to age 24 hours.

Films were prepared from this compound through a coagulant dip process on ceramic plates. The coagulant was a 30% aqueous calcium nitrate solution containing 0.01 parts Tergitol Minfoam 1X. It was applied by dipping and immediately removing hot ceramic plates (approximately 70° C.) into room temperature coagulant solution. The coagulant coated plates were then partially dried at 70° C. and dipped into the latex compound. The plates, now coated with a wet coagulated film, were then removed from the latex compound and leached for 4 minutes in a 35° C. water bath. They were then dried for 30 minutes at 70° C. and then cured for 15 minutes at 132° C. The cured films were then removed from the plates and equilibrated for at least 24 hours prior to testing.

### Example 4

### Films Prepared Adding Only Zinc Oxide as a Crosslinking Agent

A latex compound was prepared by adding 1.25 phr zinc oxide dispersion, and 1.5 phr titanium dioxide dispersion (as a pigment) to 100 phr carboxylated nitrile latex DR3988 (Dow Reichhold Specialty Latex). During the compounding the pH was raised to 9.4 using ammonium hydroxide and the total solids of the system taken to 30% by adding demineralized water. The compound was allowed to age 24 hours.

Films were prepared from this compound through a coagulant dip process on ceramic plates. The coagulant was a 30% aqueous calcium nitrate solution containing 0.01 parts Tergitol Minfoam 1X. It was applied by dipping and immediately removing hot ceramic plates (approximately 70° C.) into room temperature coagulant solution. The coagulant coated plates were then partially dried at 70° C. and dipped into the latex compound. The plates, now coated with a wet coagulated film, were then removed from the latex compound and leached for 4 minutes in a 35° C. water bath. They were then dried for 30 minutes at 70° C. and then cured for 15 minutes at 132° C. The cured films were then removed from the plates and equilibrated for at least 24 hours prior to testing.

### Example 5

### Films Prepared Using 0.5 phr Aluminum Lactate and Zinc Oxide as Crosslinking Agents

A latex compound was prepared by adding 0.5 phr aluminum lactate as a 20% aqueous solution, 1.25 phr zinc oxide dispersion, and 1.5 phr titanium dioxide dispersion (as a pigment) to 100 phr carboxylated nitrile latex DR3988 (Dow Reichhold Specialty Latex). During the compounding the pH was raised to 9.4 using ammonium hydroxide and the total solids of the system taken to 30% by adding demineralized water. The compound was allowed to age 24 hours.

Films were prepared from this compound through a coagulant dip process on ceramic plates. The coagulant was a 30% aqueous calcium nitrate solution containing 0.01 parts Tergitol Minfoam 1X. It was applied by dipping and immediately removing hot ceramic plates (approximately 70° C.) into room temperature coagulant solution. The coagulant coated plates were then partially dried at 70° C. and dipped into the latex compound. The plates, now coated with a wet coagulated film, were then removed from the latex compound and leached for 4 minutes in a 35° C. water bath. They were then dried for 30 minutes at 70° C. and then cured for 15 minutes at 132° C. The cured films were then removed from the plates and equilibrated for at least 24 hours prior to testing.

### Example 6

### Films Prepared Using 1 phr Aluminum Lactate and Zinc Oxide as Crosslinking Agents

A latex compound was prepared by adding 1 phr aluminum lactate as a 20% aqueous solution, 1.25 phr zinc oxide dispersion, and 1.5 phr titanium dioxide dispersion (as a pigment) to 100 phr carboxylated nitrile latex DR3988 (Dow Reichhold Specialty Latex). During the compounding the pH was raised to 9.4 using ammonium hydroxide and the total solids of the system taken to 30% by adding demineralized water. The compound was allowed to age 24 hours.

Films were prepared from this compound through a coagulant dip process on ceramic plates. The coagulant was a 30% aqueous calcium nitrate solution containing 0.01 parts Tergitol Minfoam 1X. It was applied by dipping and immediately removing hot ceramic plates (approximately 70° C.) into room temperature coagulant solution. The coagulant coated plates were then partially dried at 70° C. and dipped into the latex compound. The plates, now coated with a wet coagulated film, were then removed from the latex compound and leached for 4 minutes in a 35° C. water bath. They were then dried for 30 minutes at 70° C. and then cured for 15 minutes at 132° C. The cured films were then removed from the plates and equilibrated for at least 24 hours prior to testing.

### Example 7

### Films Prepared Using Aluminum Acetylacetonate and Zinc Oxide as Crosslinking Agents

A latex compound was prepared by adding 2 phr aluminum acetylacetonate as a 35% aqueous dispersion, and 1.25 phr zinc oxide dispersion to 100 phr carboxylated nitrile latex DR3988 (Dow Reichhold Specialty Latex). During the compounding the pH was raised to 9.3 using ammonium hydroxide and the total solids of the system taken to 30% by adding demineralized water. The compound was allowed to age 24 hours.

Films were prepared from this compound through a coagulant dip process on ceramic plates. The coagulant was a 30% aqueous calcium nitrate solution containing 0.01 parts Tergitol Minfoam 1X. It was applied by dipping and immediately removing hot ceramic plates (approximately 70° C.) into room temperature coagulant solution. The coagulant coated plates were then partially dried at 70° C. and dipped into the latex compound. The plates, now coated with a wet coagulated film, were then removed from the latex compound and leached for 4 minutes in a 35° C. water bath. They were then dried for 30 minutes at 70° C. and then cured for 15 minutes at 132° C. The cured films were then removed from the plates and equilibrated for at least 24 hours prior to testing.

### Example 8

### Films Prepared Applying Aluminum Lactate as a Crosslinking Agent in an Overdip

A latex compound was prepared by adding 1.25 phr zinc oxide dispersion, and 1.5 phr titanium dioxide dispersion (as a pigment) to 100 phr carboxylated nitrile latex DR3988 (Dow Reichhold Specialty Latex). During the compounding the pH was raised to 9.4 using ammonium hydroxide and the total solids of the system taken to 30% by adding demineralized water. The compound was allowed to age 24 hours.

Films were prepared from this compound through a coagulant dip process on ceramic plates. The coagulant was a 30% aqueous calcium nitrate solution containing 0.01 parts Tergitol Minfoam 1X. It was applied by dipping and immediately removing hot ceramic plates (approximately 70° C.) into room temperature coagulant solution. The coagulant coated plates were then partially dried at 70° C. and dipped into the latex compound. The plates, now coated with a wet coagulated film, were then removed from the latex compound. The films were then immediately dipped into an aluminum lactate solution and removed. The films were then leached for 4 minutes in a 35° C. water bath. They were then dried for 30 minutes at 70° C. and then cured for 15 minutes at 132° C. The cured films were then removed from the plates and equilibrated for at least 24 hours prior to testing.

The aluminum lactate solution was prepared by making a 20% by weight aqueous solution of aluminum lactate and raising the pH to 9.5 by adding concentrated ammonium hydroxide.

### Example 9

### Films Prepared Applying Aluminum Lactate as Crosslinking Agent in the Coagulant

A latex compound was prepared by adding 1.25 phr zinc oxide dispersion, and 1.5 phr titanium dioxide dispersion (as a pigment) to 100 phr carboxylated nitrile latex DR3988 (Dow Reichhold Specialty Latex). During the compounding the pH was raised to 9.4 using ammonium hydroxide and the total solids of the system taken to 30% by adding demineralized water. The compound was allowed to age 24 hours.

Films were prepared from this compound through a coagulant dip process on ceramic plates. The coagulant was a 25% aqueous calcium nitrate solution containing 5% aluminum lactate and 0.01 parts Tergitol Minfoam 1X. It was applied by dipping and immediately removing hot ceramic plates (approximately 70° C.) into room temperature coagulant solution. The coagulant coated plates were then partially dried at 70° C. and dipped into the latex compound. The plates, now coated with a wet coagulated film, were then removed from the latex compound and leached for 4 minutes in a 35° C. water bath. They were then dried for 30 minutes at 70° C. and then cured for 15 minutes at 132° C. The cured films were then removed from the plates and equilibrated for at least 24 hours prior to testing.

### Example 10

### Assessment of Film Properties

The films prepared in Examples 3, 4, 5, 6, 7, 8, and 9 were evaluated for tensile properties and durability in a combined mechanical and chemical stress durability test (CMCSD). The CMCSD data show that the conventionally cured films (Example 3) have enhanced durability over the films prepared with zinc oxide as the sole added crosslinking agent (Example 4). The CMCSD data also show that the films prepared using zinc oxide and aluminum lactate as an additional crosslinking agent (Examples 5 and 6) have enhanced durability over the films from both Example 3 (conventional vulcanization package) and Example 4 (zinc oxide as the only added crosslinking agent). The CMCSD data also show that the films prepared using zinc oxide and aluminum acetylacetonate as an additional crosslinking agent (Example 7) have enhanced durability over the films from both Example 3 (conventional vulcanization package) and Example 4 (zinc oxide as the only added crosslinking agent). The CMCSD data further show that that the films prepared using zinc oxide and aluminum lactate added as an overdip to the film and in the coagulant (Examples 8 and 9 respectively) have enhanced durability over the films from both Example 3 (conventional vulcanization package) and Example 4 (zinc oxide as the only added crosslinking agent).

| | Tensile | | | | |
|---|---|---|---|---|---|
| | Strength | Elongation | M100 | M300 | CMCSD |
| Example | (MPa) | (%) | (MPa) | (MPa) | (s) |
| 3 | 29.8 | 562 | 2.4 | 5.5 | 94 |
| 4 | 27.2 | 559 | 2.4 | 5.4 | 28 |
| 5 | 25.7 | 524 | 2.7 | 6.5 | 156 |
| 6 | 26.1 | 508 | 2.9 | 7.6 | >1800 |
| 7 | 28.0 | 538 | 2.9 | 7.9 | 1097 |
| 8 | 12.7 | 446 | 2.5 | 6.2 | >1800 |
| 9 | 22.0 | 559 | 2.1 | 4.8 | 611 |

Those skilled in the art will recognize that the present invention is capable of many modifications and variations without departing from the scope thereof. Accordingly, the detailed description and examples set forth above are meant to be illustrative only and are not intended to limit, in any manner, the scope of the invention as set forth in the appended claims.

I claim:

1. An article of manufacture comprising:
a) a carboxylated base polymer comprising an aliphatic conjugated diene monomer; and
b) an aluminum compound, wherein the aluminum compound comprises a retarding anion.

2. An article of manufacture according to claim 1, wherein the base polymer is in the form of an aqueous dispersion.

3. The article of manufacture of claim 1, wherein the retarding anion is a hydroxy-substituted mono-carboxylic acid.

4. The article of manufacture of claim 3, wherein the hydroxy-substituted monocarboxylic acid is lactic or glycolic acid.

5. The article of manufacture of claim 1, wherein the retarding anion is an enolate anion of a beta-diketone.

6. The article of manufacture of claim 5, wherein the beta-diketone is acetylacetonate.

7. The article of manufacture of claim 1, wherein the retarding anion is an enolate anion of a keto-ester.

8. The article of manufacture of claim 5, wherein the keto-ester is acetylacetate.

9. The article of manufacture of claim 1, wherein the article is in the form of a crosslinked polymeric film.

10. The article of manufacture of claim 1, wherein the article is a glove.

11. The article of manufacture of claim 1, wherein the article is a gasket.

12. The article of manufacture of claim 1, wherein the article is a coated article, wherein the coating is formed by crosslinking the polymer with the aluminum ion present in the aluminum compound.

13. The article of manufacture of claim 1, wherein the polymer is a carboxylated (meth)acrylate butadiene polymer.

14. The article of manufacture of claim 1, wherein the polymer is a carboxylated styrene-butadiene polymer.

15. The article of manufacture of claim 1, wherein the polymer is a carboxylated nitrile-butadiene polymer.

16. The article of manufacture of claim 9, wherein the film is formed from an aqueous polymer dispersion.

17. The article of manufacture of claim 9, wherein the film is elastomeric.

18. The article of manufacture of claim 9, wherein the film is made by straight dipping, coagulant dipping, casting or coating processes.

19. The article of manufacture of claim 1, wherein the composition is devoid of sulfur-based vulcanizing agents.

20. The article of manufacture of claim 1, wherein the article is in the form of a crosslinked film, which film comprises an overdip or underdip layer.

21. The article of manufacture of claim 1, wherein the polymer is selected from the group consisting of NBR, SBR, and MBR.

22. The article of manufacture of claim 1, wherein the aluminum compound is selected from the group consisting of aluminum lactate, aluminum glycolate, aluminum acetylacetonate, aluminum acetylacetate esters, aluminum citrate, aluminum tartrate, aluminum gluconate, and aluminum nitriloacetates.

23. The article of manufacture of claim 1, wherein the article is substantially devoid of accelerators.

24. A method of crosslinking a carboxylated base polymer, comprising:
a) contacting a carboxylated base polymer with an aluminum compound, wherein the aluminum compound comprises a retarding anion, and
b) maintaining contact between the aluminum compound and the carboxylated polymer at a temperature and for a time sufficient to crosslink the polymer.

25. The method of claim 24, wherein the carboxylated polymer is present in an aqueous polymer dispersion.

26. The method of claim 24, wherein the retarding anion is a hydroxy-substituted mono-carboxylic acid.

27. The method of claim 26, wherein the hydroxy-substituted monocarboxylic acid is lactic or glycolic acid.

28. The method of claim 24, wherein the retarding anion is a beta-diketone derivative.

29. The method of claim 28, wherein the beta-diketone derivative is acetylacetonate.

30. The method of claim 24, wherein the crosslinked polymer is in the form of a crosslinked polymeric film.

31. The method of claim 30, wherein the crosslinked polymeric film is in the form of a glove.

32. The method of claim 24, wherein the crosslinked polymer is in the form of a gasket.

33. The method of claim 24, wherein the crosslinked polymer forms a coating layer on a coated article.

34. The method of claim 24, wherein the polymer is a carboxylated (meth)acrylate butadiene polymer.

35. The method of claim 24, wherein the polymer is a carboxylated styrene-butadiene polymer.

36. The method of claim 24, wherein the polymer is a carboxylated nitrile-butadiene polymer.

37. The method of claim 24, wherein the base polymer, before being crosslinked, is in the form of an aqueous polymer dispersion.

38. The method of claim 37, wherein the crosslinked polymer forms an elastomeric film.

39. The method of claim 38, wherein the film is made by straight dipping, coagulant dipping, casting or coating processes.

40. The method of claim 24, wherein the crosslinked base polymer is devoid of sulfur-based vulcanizing agents.

41. The method of claim 24, wherein the crosslinked polymer is in the form of a crosslinked film, which film comprises an overdip or underdip layer.

42. The method of claim 24, wherein the polymer is selected from the group consisting of NBR, SBR, and MBR.

43. The method of claim 24, wherein the aluminum compound is selected from the group consisting of aluminum lactate, aluminum glycolate, aluminum acetylacetonate, aluminum acetylacetate esters, aluminum citrate, aluminum tartrate, aluminum gluconate, and aluminum nitriloacetates.

44. The method of claim 24, wherein the crosslinked polymer is substantially devoid of accelerators.

45. The method of claim 24, wherein the base polymer is in the form of an aqueous dispersion, the aluminum compound is added to the aqueous dispersion, and a form is dipped into the aqueous dispersion to which the aluminum compound is added.

46. The method of claim 45, wherein the dipped form is then added to a coagulant solution.

47. The method of claim 24, wherein the base polymer is in the form of an aqueous dispersion, and the aluminum compound is present in a coagulant solution, further comprising the additional steps of:
c) dipping a form into the coagulant solution, and
d) placing the dipped form into the aqueous dispersion including the base polymer.

48. The method of claim 24, wherein the base polymer is in the form of an aqueous dispersion, and the aluminum compound is present in a solution or dispersion, further comprising the additional steps of:
c) placing a form into a coagulant solution
d) placing the dipped form into the aqueous dispersion of the base polymer to form a wet film, and
e) contacting the wet film layer with the solution or dispersion containing the aluminum compound.

49. The method of claim 24, wherein the base polymer is in the form of an aqueous dispersion, and the aluminum compound is present in a solution or dispersion further comprising the additional steps of:
c) contacting a form with a solution or dispersion containing the aluminum compound,
d) dipping the contacted form into a solution or dispersion containing the coagulant, and
e) placing the dipped form into the aqueous dispersion of the polymer to form a wet film, wherein these steps can be performed in any desired order.
